(19) United States
(12) Patent Application Publication
(10) Pub. No.: US 2009/0142118 A1
(43) Pub. Date: Jun. 4, 2009

(54) Distribution of Printer Paper

(75) Inventors: Markus Bilger, Trossingen (DE); Juergen Goetz, Villingen-Schwenningen (DE); Thomas Riester, Villingen-Schwenningen (DE); Michael Steiert, Villingen-Schwenningen (DE)

Correspondence Address: K&L Gates LLP, P.O. BOX 1135, CHICAGO, IL, 60690, US

(73) Assignee: Siemens Aktiengesellschaft, Munich (DE)

(21) Appl. No.: 12/367,809

(22) Filed: Feb. 9, 2009

Related U.S. Application Data
(63) Continuation of application No. 10/561,493, filed on Nov. 3, 2005, now abandoned.
Application No. 10/561,493 is a continuation of application No. PCT/DE03/02750, filed on Aug. 18, 2003.

(30) Foreign Application Priority Data
Sep. 6, 2002 (DE) 102 41 362.2

(51) Int. Cl. B41J 15/00

(52) U.S. Cl. 400/611

(57) ABSTRACT

The invention relates to the distribution of printer paper via a housing flap of a printer, the housing flap being rotatably mounted about an axle by use of a hinge, and at least one central part of the hinge may be a printing paper opening having at least a width B.

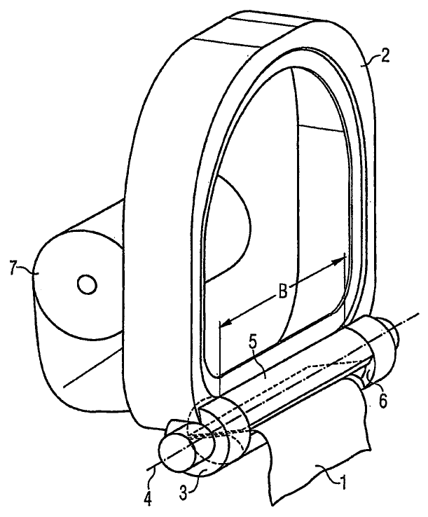

### CROSS REFERENCE TO RELATED APPLICATIONS

The present application is a continuation of international application PCT/DE2003/002750, filed 18 Aug. 2003, and further claims priority to German application 10241362.2, filed 6 Sep. 2002, the both of which are herein incorporated by reference.

### BACKGROUND OF THE INVENTION

The invention relates to the distribution of printer paper via a housing flap of a printer, the housing flap being rotatably mounted about an axle by means of a hinge.

In printers, in particular in printers for office calculating machines, cash registers, tachographs or similar small printers, the paper is often distributed via a housing flap, via which the paper supply of the printer is also put in. In this case, the paper is distributed via a more or less complicated mechanism at a specific angle with respect to the housing. When the cover is opened, the printing operation is stopped, and therefore so is the paper distribution. If the paper distribution is not stopped, there is the risk of a paper jam.

In order to avoid this, the lengthened paper path when the cover is opened is matched by the fact that printer paper is removed from the paper supply, for example a roll, in a corresponding amount. A more or less complex mechanism in this case additionally has the effect that the paper is kept taut during the entire operation. When the cover is folded back and closed, the mechanism effects a controlled reverse travel of the paper released from the paper supply and therefore prevents a paper jam when paper distribution operation is resumed.

The mechanism mentioned above is complex and susceptible to faults and leads to high production costs.

### SUMMARY OF THE INVENTION

The object of the invention is to provide paper distribution which, with lower production costs, reliably ensures higher operational reliability and interruption-free operation under all operating conditions.

This object is achieved in that printer paper is distributed via a housing flap of a printer, the housing flap being rotatably mounted about an axle by means of a hinge and, in at least a central part of the hinge, having a printing paper lead-through, at least over a width which corresponds to a paper width.

With the measures mentioned above, the printing paper lead-through for the paper is positioned directly at the point of rotation of the housing flap. Irrespective of the position of the housing flap, whether this is opened or closed, it is thus possible for paper always to be distributed via the paper lead-through unimpeded and without the risk of a paper jam and without the use of a more or less complicated mechanism too. In an expanded embodiment, the angle of the paper lead-through can additionally always be changed freely and continuously.

For the paper distribution according to the invention, the form in which the paper supply of the printer is accommodated in the printer is of subordinate importance. It is obvious here to keep the paper supply in roll form in the printer, which means that friction-free continuous printing can be implemented without difficulty. Alternatively, other forms of paper supply can also be used. Individual sheet stacks or continuous sheet stacks are mentioned as examples.

In a further embodiment, the paper lead-through can be used as part of a printer for tachographs since, in particular, these printers are subjected to severe vibrations and temperature fluctuations, in particular in commercial vehicles. For this reason, the simplicity of the paper distribution according to the invention is particularly advantageous for this printer type and area of application.

### BRIEF DESCRIPTION OF THE SEVERAL VIEWS OF THE DRAWINGS

In the following text, the invention is described in more detail by using an exemplary embodiment and a FIGURE.

The FIGURE shows a housing flap.

### DETAILED DESCRIPTION OF THE INVENTION

The housing flap illustrated in the FIGURE is of subordinate importance to the idea of the invention and could also have any other form differing from the present illustration. The critical feature is the fitting of a paper lead-through 6 in a central part 5 of a hinge 3. Distribution of paper is therefore possible irrespective of the position of the housing flap 2. The housing flap 2 is rotatably mounted about an axle by means of the hinge 3. It can be seen that no further mechanism is required for the paper lead-through 6, in particular in relation to the position of the housing flap 2.

The position of the paper lead-through on the central part 5 can be matched to the specific application and is not limited to a plane with the axle. Likewise, the form of the paper lead-through, whether this runs in a curve or in a straight line, for example, depends on the respective application.

The idea of the invention can be applied not only exclusively to the example of a tachograph printer shown here but likewise to all other forms and sizes of printers.

We claim:

1. A distribution means of printer paper via a housing flap of a printer, comprising:
a hinge arranged so that the housing flap is rotatably mounted about an axle, and
at least a central part of the hinge has a printing paper lead-through, at least over a width.

2. The distribution means according to claim 1, further comprising means for keeping the printer paper in roll form in the printer.

3. The distribution means according to claim 1, wherein the printer paper is kept in stack form in the printer.

4. The distribution means according to claim 3, wherein the paper supply comprises individual sheets.

5. The distribution means according to claim 2, wherein the paper supply comprises continuous paper.

6. The distribution means according to claim 1, further comprising means for running the printing paper lead-through through the axle of the hinge.

7. The distribution means according to claim 1, further comprising means for rotating the printing paper lead-through about the axle.

8. The distribution means according to claim 1, wherein the printing paper lead-through runs in a curve.

9. The distribution means according to claim 1, wherein the printer is a tachograph printer.
